(19) United States
(12) Patent Application Publication
(10) Pub. No.: US 2010/0287932 A1
(43) Pub. Date: Nov. 18, 2010

(54) INTERNAL-COMBUSTION-ENGINE CONTROL APPARATUS

(75) Inventors: Hideyuki TANAKA, Chiyoda-ku (JP); Noriyuki Inoue, Chiyoda-ku (JP); Yohei Akashi, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Tokyo (JP)

(21) Appl. No.: 12/697,772

(22) Filed: Feb. 1, 2010

(30) Foreign Application Priority Data
May 14, 2009 (JP) 2009-117678

(51) Int. Cl. F02D 23/00; F02B 33/44

(52) U.S. Cl. 60/602; 60/607; 60/605.2

(57) ABSTRACT

An electrically assisted turbocharger is provided; in the case where an internal combustion engine rotates at low rotation speed, the output thereof is secured by adjusting the flow rate in a recirculation path while supercharging with electrically assisting torque, and in the case where the internal combustion engine rotates at high rotation speed, electrically assisting torque compensates the inertia of at least a turbine wheel, a compressor impeller, and a motor; as a result, not only unnecessary consumption of electric energy is avoided, but also desired supercharging can be performed by the electrically assisted turbocharger.

### BACKGROUND OF THE INVENTION

1. Field of the Invention

The present invention relates to an internal-combustion-engine control apparatus provided with an electrically assisted turbocharger.

2. Description of the Related Art

To date, there has been proposed an internal combustion engine in which, in its air-intake path, an exhaust turbosupercharger utilizing exhaust gas and an electrically assisted turbocharger that is driven by a motor are provided, in order to realize high mileage of a vehicle such as an automobile and to enlarge the output of an internal combustion engine (e.g., refer to Japanese Patent Application Laid-Open No. 2008-19835). In a conventional internal combustion engine disclosed in Japanese Patent Application Laid-Open No. 2008-19835, in the case where, due to insufficient exhaust gas, no desired supercharging pressure can be obtained with an exhaust turbosupercharger or in the case where the internal combustion engine rotates at low speed, the foregoing motor is driven so that the electrically assisted turbocharger performs supercharging; in the case where the desired supercharging pressure can be obtained with the exhaust turbosupercharger, the exhaust turbosupercharger performs supercharging.

In general, in the case where supercharging is performed while the internal combustion engine is in a low-speed rotation zone, a surge is likely to occur when the capacity of the supercharger is large; when a surge occurs, damage to the internal combustion engine and air-intake system thereof can be produced. Accordingly, to date, there has been proposed an internal-combustion-engine control apparatus in which, in order to prevent the occurrence of a surge, there is provided a recirculation path for returning air at the outlet of the compressor in the supercharger to the inlet of the compressor; an air cooler is provided in the recirculation path; air that flows into the recirculation path from the outlet of the compressor is cooled by the air cooler and then is returned to the inlet of the compressor (e.g., refer to National Publication of International Patent Application No. 2007-528956).

In a conventional apparatus disclosed in Japanese Patent Application Laid-Open No. 2008-19835, there has been a problem that, in the case where supercharging is performed by an electrically assisted turbocharger when the internal combustion engine is in a low-speed rotation mode where sufficient air cannot be obtained, a surge may occur when the capacity of the electrically assisted turbocharger is large, whereby there cannot be performed supercharging with a sufficient quality for a vehicle. Additionally, there has been a problem that, when the capacity of the electrically assisted turbocharger is reduced in order to prevent the occurrence of a surge, the output of the internal combustion engine decreases when the internal combustion engine rotates at high speed, due to insufficient supercharging pressure.

In contrast, in a conventional apparatus disclosed in National Publication of International Patent Application No. 2007-528956, there has been a problem that, in the case where the motor assists the compressor with driving power while intake air is recirculated, the assist cannot be performed efficiently because no measure for the power consumption of the motor is considered.

### SUMMARY OF THE INVENTION

The present invention has been implemented in order to solve the foregoing problems in the conventional apparatuses; the objective thereof is to obtain an internal-combustion-engine control apparatus in which the power consumption of an electrically assisted turbocharger is reduced and the electrically assisted turbocharger can perform desired supercharging.

An internal-combustion-engine control apparatus according to the present invention is provided with an electrically assisted turbocharger including a turbine wheel that is provided in an exhaust path of an internal combustion engine mounted in a vehicle and is driven with exhaust gas energy of the internal combustion engine, a compressor impeller that is provided in an air-intake path of the internal combustion engine and is driven by the turbine wheel so as to compress the air in the air-intake path, and a motor that exerts assisting torque on the compressor impeller, as may be necessary and a control means that controls the electrically assisted turbocharger, based at least on an acceleration intention of a driver who drives the vehicle; the internal-combustion-engine control apparatus is characterized in that output torque of the internal combustion engine is increased by supercharging the internal combustion engine with air compressed by the compressor impeller; and when the acceleration intention is to require acceleration that is more rapid than a predetermined value, the control means controls the motor in such a way that the motor generates assisting torque for compensating inertia moments of at least the turbine wheel, the compressor impeller, and the motor.

Moreover, an internal-combustion-engine control apparatus according to the present invention is provided with an electrically assisted turbocharger including a turbine wheel that is provided in an exhaust path of an internal combustion engine mounted in a vehicle and is driven with exhaust gas energy of the internal combustion engine, a compressor impeller that is provided in an air-intake path of the internal combustion engine and is driven by the turbine wheel so as to compress the air in the air-intake path, and a motor that exerts assisting torque on the compressor impeller, as may be necessary and a control means that controls the electrically assisted turbocharger, based at least on an acceleration intention of a driver who drives the vehicle and a rotation speed of the internal combustion engine; the internal-combustion-engine control apparatus is characterized in that output torque of the internal combustion engine is increased by supercharging the internal combustion engine with air compressed by the compressor impeller; and in the case where the acceleration intention is not to require acceleration that is more rapid than a predetermined value and the rotation speed is the same as or lower than a predetermined rotation speed, the control means controls the motor in such a way that the motor drives the compressor impeller with assisting torque thereof, and in the case where the acceleration intention is not to require acceleration that is more rapid than the predetermined value and the rotation speed is higher than the predetermined rotation speed, the control means de-energizes the motor so that the compressor impeller is driven only with torque of the turbine wheel.

Still moreover, an internal-combustion-engine control apparatus according to the present invention is provided with an electrically assisted turbocharger including a turbine wheel that is provided in an exhaust path of an internal combustion engine mounted in a vehicle and is driven with exhaust gas energy of the internal combustion engine, a compressor impeller that is provided in an air-intake path of the internal combustion engine and is driven by the turbine wheel so as to compress the air in the air-intake path, and a motor that exerts assisting torque on the compressor impeller, as may be necessary and a control means that controls the electrically assisted turbocharger, based at least on a rotation speed of the internal combustion engine; the internal-combustion-engine control apparatus is characterized in that output torque of the internal combustion engine is increased by supercharging the internal combustion engine with air compressed by the compressor impeller; and when the output torque of the internal combustion engine is increased at a more higher rotation speed than a predetermined rotation speed of the internal combustion engine, the control means controls the motor in such a way that the motor generates assisting torque for compensating inertia moments of at least the turbine wheel, the compressor impeller, and the motor.

In the internal-combustion-engine control apparatus according to the present invention, the acceleration intention of the driver is preferably obtained based on the displacement speed of a throttle position of the internal combustion engine; in the case where the displacement speed of the throttle position is the same as or higher than a predetermined value, it is determined that the acceleration intention of the driver is to require acceleration that is more rapid than the predetermined value, and in the case where the displacement speed of the throttle position is lower than the predetermined value, it is determined that the acceleration intention of the driver is not to require acceleration that is more rapid than the predetermined value.

In the internal-combustion-engine control apparatus according to the present invention, there are preferably included a recirculation path for returning air at the downstream side of the compressor impeller in the air-intake path to the upstream side of the compressor impeller and an air flow rate adjusting means that controls the ratio of an air pressure at the downstream side of the compressor impeller to an air pressure at the upstream side of the compressor impeller by adjusting an air flow rate in the recirculation path; the air flow rate adjusting means adjusts an air flow rate in the recirculation path, based at least on an air pressure at the downstream side of the compressor impeller and the assisting torque of the motor. In this case, the air flow rate adjusting means adjusts the flow rate of air that recirculates through the recirculation path, so that there can be prevented a surge that is caused through the compression of air by the compressor impeller.

In the internal-combustion-engine control apparatus according to the present invention, it is desirable that the rotation speed of the electrically assisted turbocharger is lower than 200,000 [rpm], preferably 140,000 [rpm], and further preferably 80,000 [rpm] and the electrically assisted turbocharger has a capacity where the ratio of an air pressure at the downstream side of the compressor impeller to an air pressure at the upstream side of the compressor impeller is the same as or larger than 2.0.

Moreover, in the internal combustion engine, it is desirable that there is provided a cylinder with a capacity of smaller than 1.4 [L], preferably 1.2 [L], the rotation speed of the electrically assisted turbocharger is lower than 200,000 [rpm], preferably 140,000 [rpm], and further preferably 80,000 [rpm], and the electrically assisted turbocharger has a capacity where the ratio of an air pressure at the downstream side of the compressor impeller to an air pressure at the upstream side of the compressor impeller is the same as or larger than 2.0.

In an internal-combustion-engine control apparatus according to the present invention, there is provided a control means that controls the electrically assisted turbocharger, based at least on an acceleration intention of a driver who drives the vehicle; when the acceleration intention is to require acceleration that is more rapid than a predetermined value, the control means controls the motor in such a way that the motor generates assisting torque for compensating inertia moments of at least the turbine wheel, the compressor impeller, and the motor. As a result, it is made possible that the power consumption of the electrically assisted turbocharger is reduced and the electrically assisted turbocharger can perform desired supercharging; therefore, there can be carried out the downsizing of an internal combustion engine, which cannot be realized by a turbocharger that is driven only with exhaust gas energy.

Moreover, in an internal-combustion-engine control apparatus according to the present invention, there is provided a control means that controls the electrically assisted turbocharger, based at least on an acceleration intention of a driver who drives the vehicle and a rotation speed of the internal combustion engine; in the case where the acceleration intention is not to require acceleration that is more rapid than a predetermined value and the rotation speed is the same as or lower than a predetermined rotation speed, the control means controls the motor in such a way that the motor drives the compressor impeller with assisting torque thereof, and in the case where the acceleration intention is not to require acceleration that is more rapid than the predetermined value and the rotation speed is higher than the predetermined rotation speed, the control means de-energizes the motor so that the compressor impeller is driven only with torque of the turbine wheel. As a result, it is made possible that the power consumption of the electrically assisted turbocharger is reduced and the electrically assisted turbocharger can perform desired supercharging; therefore, there can be carried out the downsizing of an internal combustion engine, which cannot be realized by a turbocharger that is driven only with exhaust gas energy.

Still moreover, in an internal-combustion-engine control apparatus according to the present invention, there is provided a control means that controls the electrically assisted turbocharger, based at least on a rotation speed of the internal combustion engine; when the output torque of the internal combustion engine is increased at a more higher rotation speed than a predetermined rotation speed of the internal combustion engine, the control means controls the motor in such a way that the motor generates assisting torque for compensating inertia moments of at least the turbine wheel, the compressor impeller, and the motor. As a result, it is made possible that the power consumption of the electrically assisted turbocharger is reduced and the electrically assisted turbocharger can perform desired supercharging; therefore, there can be carried out the downsizing of an internal combustion engine, which cannot be realized by a turbocharger that is driven only with exhaust gas energy.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a configuration diagram illustrating the overall configuration of an internal-combustion-engine control apparatus according to Embodiment 1 of the present invention;

FIG. 2 is a flowchart representing the operation of the control device in an internal-combustion-engine control apparatus according to Embodiment 1 of the present invention; and

FIG. 3 is an explanatory graph for explaining the operation of the internal-combustion-engine control apparatus according to Embodiment 1 of the present invention.

### DETAILED DESCRIPTION OF THE PREFERRED EMBODIMENTS

### Embodiment 1

An internal-combustion-engine control apparatus according to Embodiment 1 of the present invention will be explained in detail with reference to the accompanying drawings.

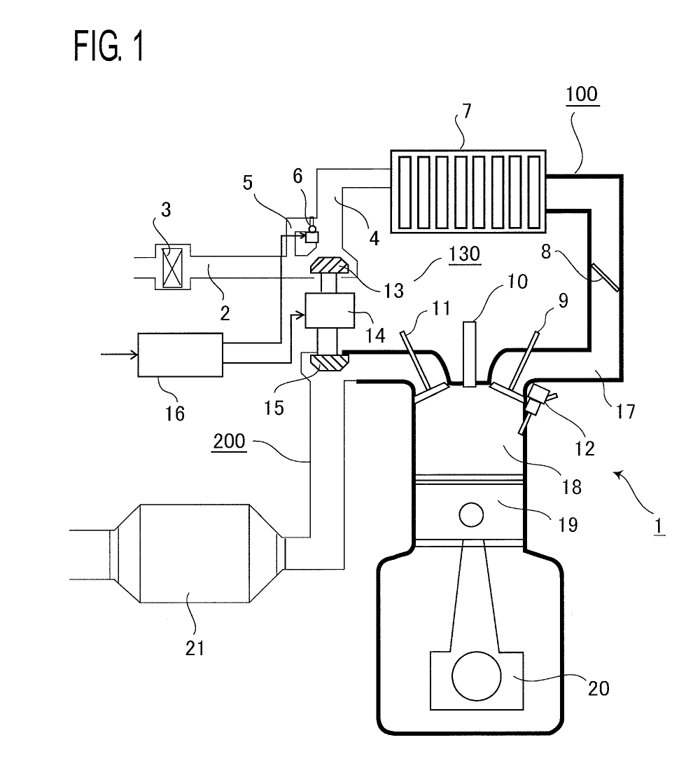

FIG. 1 is a configuration diagram illustrating the overall configuration of an internal-combustion-engine control apparatus according to Embodiment 1 of the present invention. In FIG. 1, an internal combustion engine 1 is a direct-injection multi-cylinder internal combustion engine where an injector directly injects fuel into a cylinder; however, in FIG. 1, only one cylinder is illustrated as a cross-sectional view. The internal combustion engine 1 is configured in such a way that, by making a motor, described later, drive the compressor impeller of a supercharger, more supercharging of intake air is performed so that not only high output but also high mileage can be realized.

It goes without saying that the internal combustion engine 1 maybe either a direct-injection internal combustion engine where fuel is directly injected into a cylinder or a port-injection internal combustion engine where fuel is injected into an air-intake path at the at the downstream side of a throttle valve.

The internal combustion engine 1 includes a cylinder 18 and a piston 19 that is incorporated in the cylinder 18 and reciprocates in the axis direction. The reciprocal movement of the piston 19 is converted by a crank 20 into rotation movement and becomes the rotation output of the internal combustion engine 1. An injector 12 fixed to the cylinder 18 injects a fuel directly into the combustion chamber of the cylinder 18. An ignition plug 10 is provided at the top of the cylinder 18. One end of an air-intake path 100 communicates with the inside of the combustion chamber of the cylinder 18, and the other end thereof is opened to the air through an air cleaner 3. One end of an exhaust path 200 communicates with the inside of the combustion chamber of the cylinder 18, and the other end thereof is opened to the air through an exhaust purification catalyst 21.

A throttle valve 8 provided in the air-intake path 100 adjusts the amount of intake air that is made to enter the combustion chamber of the cylinder 18. An air-intake valve 9 is provided at the coupling portion for coupling the combustion chamber of the cylinder 18 with a downstream path 17, situated at the downstream side of the throttle valve 8, in the air-intake path 100; the air-intake valve 9 opens or closes the air-intake path 100 in conjunction with the operation of the piston 19 and the crank 20. Similarly, an exhaust valve 11 provided at the coupling portion for coupling the combustion chamber of the cylinder 18 with the exhaust path 200 opens or closes the exhaust path 200 in conjunction with the operation of the piston 19 and the crank 20.

An electrically assisted turbocharger 130 is provided with a compressor impeller 13 that compresses air absorbed into the air-intake path 100 through the air cleaner 3, a motor 14 whose rotor shaft is coupled with the axle of the compressor impeller 13, and a turbine wheel 15 whose axle is coupled with the rotor shaft of the motor 14 and that is driven with exhaust gas, described later. The motor 14 is controlled in such a way as described later by a control means 16 that controls the electrically assisted turbocharger 130. An inter cooler 7 provided in a downstream path 4, situated at the downstream side of the compressor impeller 13, in the air-intake path 100 cools air whose temperature has increased due to the compression operation of the compressor impeller 13 of the electrically assisted turbocharger 130, in order to raise the efficiency in filling air.

A recirculation path 5 communicates with an upstream path 2, situated at the upstream side of the compressor impeller 13, in the air-intake path 100 and the downstream path 4; the recirculation path 5 returns air in the vicinity of the downstream path 4 to the upstream path 2. An air flow rate adjusting means 6 provided in the recirculation path 5 is controlled by the control means 16 so as to adjust the amount of air to be recirculated through the recirculation path 5.

In the internal-combustion-engine control apparatus, according to Embodiment 1 of the present invention, which is configured as described above, at first, the air cleaner 3 removes dust and the like in the air absorbed through the air-intake path 100 into the internal combustion engine 1; then, the air enters the upstream path 2, which is situated at the upstream side of the compressor impeller 13. After that, the air in the upstream path 2 is compressed by the compressor impeller 13 and enters the intercooler 7 through the downstream path 4, situated at the downstream side of the compressor impeller 13.

On the other hand, part of the air that has been compressed by the compressor impeller 13 of the electrically assisted turbocharger 130 is returned, through the recirculation path 5, from the downstream path 4, situated at the downstream side of the compressor impeller 13, to the upstream path 2. In this situation, in the case where a surge may be caused by the air compressed by the compressor impeller 13, the air flow rate adjusting means 6 adjusts the amount of air to be recirculated through the recirculation path 5, based on a control signal from the control means 16.

The temperature of the air in the downstream path 4, situated at the downstream side of the compressor impeller 13, is raised, through compression, to be higher than the temperature of the air in the upstream path 2; thus, an air cooling means maybe provided in the recirculation path 5 in order to reduce the temperature increase of air that is recirculated through the recirculation path 5. Alternatively, for example, one end of the recirculation path 5 may be coupled with the downstream path, situated at the downstream side of the intercooler 7, so that air cooled by the intercooler 7 is returned to the upstream path 2, situated at the upstream side of the compressor impeller 13.

The air compressed by the compressor impeller 13 of the electrically assisted turbocharger 130 enters the intercooler 7 through the downstream path 4, situated at the downstream side of the compressor impeller 13. The intercooler 7 lowers the temperature, of the air, which increases due to increase in pressure caused through compression by the impeller 13, so that the efficiency in filling air to be supercharged is raised. The high-pressure air that has been cooled by the intercooler 7 reaches the downstream path 7, situated at the downstream side of the throttle valve 8, by way of the throttle valve 8.

When the air-intake valve 9 opens in conjunction with the operation of the piston 19, the air in the downstream path 17, situated at the downstream side of the throttle valve 8, is filled into the combustion chamber of the cylinder 18, and is mixed, at a predetermined air-fuel ratio, with a fuel that is injected into the combustion chamber by the injector 12, so as to become a fuel-air mixture. This fuel-air mixture is ignited to burn by the ignition plug 10; then, through the exhaust valve 11 that opens in conjunction with the operation of the piston 19, the burned mixture is exhausted, as an exhaust gas, to the exhaust path 200; after that, the exhaust gas is purified by the exhaust purification catalyst 21, and then is exhausted to the air.

The turbine wheel 15, of the electrically assisted turbocharger 130, provided in the exhaust path 200 is driven with an exhaust gas that is exhausted from the inside of the cylinder 18 to the exhaust path 200, and then exerts driving force on the compressor impeller 13 by the intermediary of the rotor shaft of the motor 14.

Next, the operation of the internal-combustion-engine control apparatus according to Embodiment 1 of the present invention will be explained. The control means 16 generates a command signal, based on the detection values such as the rotation speed of the internal combustion engine 1, the throttle position, the air-intake pressure (referred to simply as intake pressure, hereinafter), and the air-intake amount, and feed the command signal to the motor 14 of the electrically assisted turbocharger 130. The motor 14 is controlled based on the command signal from the control means 16.

The throttle position is obtained based on a signal, from an electronic throttle, on which a driver's accelerator operation is reflected; however, in a vehicle or the like equipped with no electronic throttle, an accelerator pedal position, for example, may be utilized. The air-intake pressure can be detected and obtained by providing, for example, a pressure sensor or the like in the downstream path 17, situated at the downstream side of the throttle valve 8. The air-intake amount can be detected by providing an air flow sensor or the like at a position after the air cleaner 3, i.e., in the upstream path 2 or the like, situated at the upstream side of the compressor impeller 13.

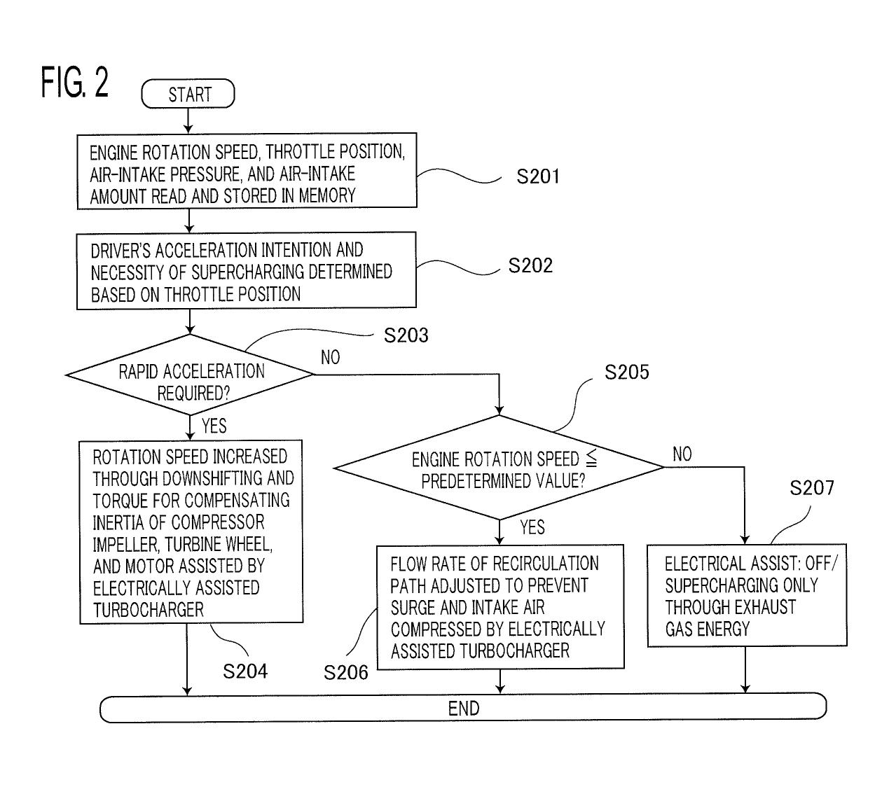

FIG. 2 is a flowchart representing the operation of the control device in an internal-combustion-engine control apparatus according to Embodiment 1 of the present invention. The flowchart represented in FIG. 2 includes the steps S201 through S207 between “START” and “END”. In FIG. 2, in the step S201, at first, the control means 16 reads the rotation speed of the internal combustion engine 1, the throttle position, the intake pressure, and the air-intake amount and stored then in a microcomputer memory (unillustrated).

In the following step S202, the control means 16 determines based on the throttle position whether or not supercharging is required because the driver has an intention to accelerate the vehicle. The determination can be carried out in such a way, for example, that the displacement speed of the throttle opening degree is calculated, and in the case where the calculated displacement speed of the throttle opening degree is larger than a first predetermined value, which is preliminarily set, it is determined that the driver has an intention to accelerate the vehicle.

In the case where it is determined in the step S202 that the driver has an intention to accelerate the vehicle, it is determined in the following step S203 whether or not rapid acceleration is required. This particular determination may be carried out in such a way that a predetermined threshold value corresponding to a vehicle is preliminarily stored and it is determined whether or not the displacement speed of the throttle opening degree exceeds the threshold value. In other words, the determination can be carried out in such a way that, in the case where the calculated displacement speed of the throttle opening degree is the same as or larger than a second predetermined value that is larger than the first predetermined value, it is determined that the driver has an intention to accelerate the vehicle rapidly; and in the case where the calculated displacement speed of the throttle opening degree is smaller than the second predetermined value, it is determined that the driver has an intention to accelerate the vehicle not rapidly but slowly. In the case where the outcome of the determination performed in the step S203 becomes “Yes” (rapid acceleration is required), the step S203 is followed by the step S204.

In the step S204, by downshifting the transmission so as to raise the rotation speed of the internal combustion engine 1, the turbine wheel 15 is driven with exhaust gas energy; the motor 14 is energized based on a signal from the control means 16 so as to generate assisting torque for compensating the inertia of at least the compressor impeller 13, the turbine wheel 15, and the motor 14.

In contrast, in the case where it is determined in the step S203 that the driver does not have an intention to accelerate the vehicle rapidly (the result of the determination is “NO”), the step S203 is followed by the step S205, where it is determined whether or not the rotation speed of the internal combustion engine 1 is the same as or smaller than a predetermined value, which is preliminarily set. The predetermined value is determined in accordance with the capacity of the internal combustion engine 1 or the shape of the compressor impeller 13 or the turbine wheel 15 of the electrically assisted turbocharger 130.

In general, in the case where the supercharger is a large-capacity mechanical turbocharger that is driven only with exhaust gas energy in an internal combustion engine, by mounting the large-capacity mechanical turbocharger in a small-capacity internal combustion engine, supercharging can be performed in a zone where the rotation speed of the internal combustion engine is high; however, there have been problems that supercharging cannot be performed in a zone where the rotation speed of the internal combustion engine is low and that, because the inertia moment becomes large compared with a small-capacity turbocharger, a response delay, i.e., a turbo lag occurs. In the internal-combustion-engine control apparatus according to Embodiment 1 of the present invention, even in the case where there is utilized a large-capacity turbine wheel that is driven with exhaust gas, electrical assist enables supercharging even in a zone where the rotation speed of the internal combustion engine 1 is low.

In the case where it is determined in the step S205 that the rotation speed of the internal combustion engine 1 is smaller than a predetermined value, which is preliminarily determined in accordance with a vehicle (the result of the determination is “YES”), the step S205 is followed by the step S206, where the motor 14 is energized based on a command signal from the control means 16; the compressor impeller 13 is driven through the electrically assisting torque. In this situation, if there is a possibility that a surge occurs in the air-intake path 100, the control means 16 feeds a command signal to the air flow rate adjusting means 6, and then the flow rate in the recirculation path 5 is adjusted by the air flow rate adjusting means 6 so as to become large, whereby the occurrence of a surge is prevented.

In contrast, in the case where it is determined in the step S205 that the rotation speed of the internal combustion engine 1 is larger than the predetermined value, which is preliminarily determined in accordance with a vehicle (the result of the determination is “NO”), the step S205 is followed by the step S207. In the step S207, the motor 14 is stopped in response to a command signal from the control means 16 so that no electrically assisting torque is exerted; the supercharger 14 is driven only by the driving power, of the turbine wheel 15, produced by the exhaust gas energy, so that supercharging is performed.

In the foregoing explanation, there has been described a case where the control means 16 calculates a control signal for performing driving control of the motor 14 and a control signal for controlling the air flow rate adjusting means 6, and the respective control signals are outputted to the motor 14 and the air flow rate adjusting means 6; however, there can be demonstrated the same effect, for example, by configuring the internal-combustion-engine control apparatus in such a way that at least one of a command value for performing driving control of the motor 14 and a command value for controlling the air flow rate adjusting means 6 is calculated by an internal-combustion-engine control computer (unillustrated); the internal-combustion-engine control apparatus feeds the calculated command value to the control means 16; and the control means 16 controls the motor 14 or the air flow rate adjusting means 6 in response to the command value.

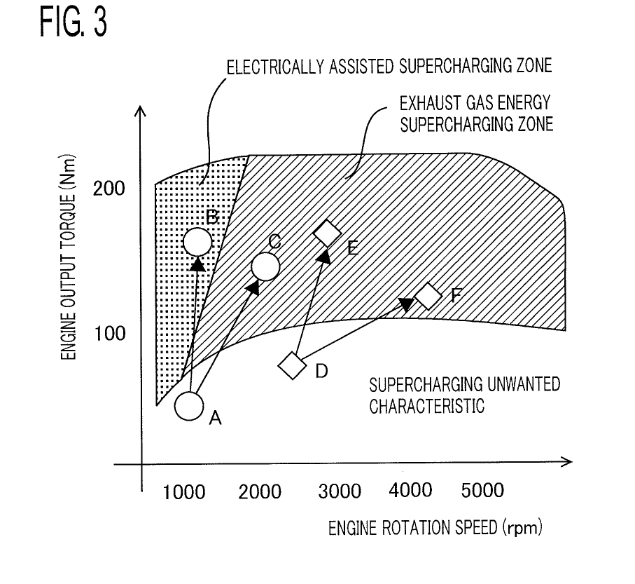

FIG. 3 is an explanatory graph for explaining the operation of the internal-combustion-engine control apparatus according to Embodiment 1 of the present invention. The explanatory graph in FIG. 3 represents, as an imaginary graph, the output characteristics of a direct-injection internal combustion engine whose cylinder capacity is 1.2 [L] and in which there is mounted a large-capacity electrically assisted turbocharger that realizes, at the rotation speed of 140,000 [rpm], the pressure ratio 2.0, which is the ratio of the air pressure in the downstream path, situated at the downstream side of the compressor impeller, to the air pressure in the upstream path, situated at the upstream side of the compressor impeller. In FIG. 3, the ordinate denotes the output torque [Nm] of an internal combustion engine, and the abscissa denotes the rotation speed [rpm] of the internal combustion engine.

In FIG. 3, in the supercharging unwanted characteristic zone, which is a zone where supercharging by the electrically assisted turbocharger 130 is not required, the motor 14 is not energized. The electrically assisted supercharging zone is a zone where because, due to insufficient exhaust gas energy, the driving force of the turbine wheel 15 can hardly be obtained, the motor 14 is energized, and supercharging is performed by driving the compressor impeller 13 with the electrically assisting torque. The exhaust gas energy supercharging zone is a zone where due to sufficient exhaust gas energy, supercharging can be performed by driving the compressor impeller 13 with the driving force exerted by the turbine wheel 15.

For example, provided that the internal combustion engine is operated at a point A, in the supercharging unwanted characteristic zone, where the rotation speed is low, supercharging by the electrically assisted turbocharger 130 is not required; therefore, the motor 14 is de-energized. At the point A, when the driver slowly steps on the acceleration pedal in order to raise the output of the internal combustion engine 1, the control means 16 determines that rapid acceleration is not required and then shifts the operating point to a point B in the electrically assisted supercharging zone.

At the point B, the motor 14 is energized based on a command signal from the control means 16; the compressor impeller 13 is driven through the electrically assisting torque. In the case where there is a possibility that a surge is caused, the air flow rate adjusting means 6 is controlled to make the air flow rate in the recirculation path 5 larger, so that a predetermined supercharging pressure can be obtained while avoiding the surge, and hence desired output torque of the internal combustion engine 1 can be obtained.

In contrast, in the case where, at the point A, the driver rapidly steps on the accelerator pedal in order to raise the output of the internal combustion engine 1, the control means 16 determines that rapid acceleration is required and shifts the operating point to a point C in the exhaust gas energy supercharging zone. At the point C, the compressor impeller 13 is driven with driving torque of the turbine wheel 15 caused by exhaust gas energy. In this situation, the motor 14 is energized based on a command signal from the control means 16 so as to generate electrically assisting torque for compensating the inertia of at least the compressor impeller, the turbine wheel, and the motor. As a result, a turbo lag can be prevented, and hence the driver can obtain high-operability acceleration performance.

Next, for example, it is assumed that the internal combustion engine 1 is operated at a point D in the supercharging unwanted characteristic zone. Because, in the case of the point D, no supercharging is required, the motor 14 is de-energized. When, at the point D, the driver slowly steps on the acceleration pedal in order to raise the output of the internal combustion engine 1, the control means 16 determines that rapid acceleration is not required and then shifts the operating point to a point E. In this case, the internal combustion engine 1 is not required to raise its output rapidly, and hence supercharging only with exhaust gas energy enables sufficiently high-operability acceleration performance to be obtained even without electrically assisting torque to be generated by the motor 14; thus, the motor 14 is kept de-energized, and the electric assisting is turned off.

In contrast, when, at the point D, the driver rapidly steps on the acceleration pedal in order to raise the output of the internal combustion engine 1, the control means 16 determines that rapid acceleration is required and then shifts the operating point to a point F in the exhaust gas energy supercharging zone. In this situation, the motor 14 is energized based on a command signal from the control means 16 so as to generate electrically assisting torque for compensating the inertia of at least the compressor impeller, the turbine wheel, and the motor. As a result, a turbo lag can be prevented, and hence the driver can obtain high-operability acceleration performance.

As described above, in an internal-combustion-engine control apparatus according to Embodiment 1 of the present invention, in the case where rapid acceleration is required, in the exhaust gas energy supercharging zone, the motor is energized in such a way as to generate electrically assisting torque for compensating the inertia of the turbine wheel, the compressor impeller, and the motor, whereby not only electric power required by the electrical assisting turbocharger can be saved, but also the internal combustion engine can be operated at an operating point where the thermal efficiency of the internal combustion engine is high; as a result, the gasoline mileage can be raised. Moreover, not only the gasoline mileage can be raised, but also the internal combustion engine can rapidly respond to generate its output in accordance with the accelerator operation by a driver; therefore, the operability can also be raised.

Still moreover, in an internal-combustion-engine control apparatus according to Embodiment 1 of the present invention, not only supercharging can be performed while adjusting the flow rate in a recirculation path in order to prevent a surge, but also electrically assisted supercharging at a time when the internal engine rotates at low rotation speed can be performed while adjusting the flow rate in the recirculation path, as may be necessary, in accordance with the driver's operation; therefore, the power consumption is low, and the load on the motor can be reduced; thus, because the vehicle is driven in an electric-power load condition that cooperates with exhaust gas energy, the gasoline mileage performance can be raised.

For example, a naturally-aspirated internal combustion engine with a cylinder capacity of 2.0 [L] can also demonstrate the same effect as Embodiment 1; however, a direct-injection internal combustion engine with a cylinder capacity of 1.2 [L] that is provided with an electrically assisted turbocharger is superior in terms of thermal efficiency, especially in the case where it is operated under the condition that the rotation speed of the internal combustion engine is lower than 3,000 [rpm] and the torque of the internal combustion engine is smaller than 100 [Nm].

Furthermore, in an internal-combustion-engine control apparatus according to Embodiment 1 of the present invention, in the case where an internal combustion engine rotates at low rotation speed, the output thereof is secured by supercharging with electrically assisting torque while adjusting the flow rate in a recirculation path, and in the case where the internal combustion engine rotates at high rotation speed, the electrically assisting torque compensates, as may be necessary, the inertia of the turbine, the compressor, and the motor so that unnecessary consumption of electric energy is reduced and the maximum supercharging pressure is raised; therefore, there can be carried out the downsizing of an internal combustion engine, which cannot be realized by a turbocharger that is driven only with exhaust gas energy.

With regard to Embodiment 1 of the present invention, there has been described a mode where an electrically assisted turbocharger is applied to a direct-injection internal combustion engine with a cylinder capacity of 1.2 [L] so that the gasoline mileage performance is raised; however, in general, a gasoline internal combustion engine with a cylinder capacity of smaller than 1.4 [L] demonstrates superior gasoline mileage performance when it is operated in a practical zone where the rotation speed of the engine is lower than 3,000 [rpm] and the torque of the internal combustion engine is smaller than 100 [Nm]. An internal-combustion-engine control apparatus according to the present invention can obtain the same effect when applied to an internal combustion engine with a cylinder capacity of smaller than 1.4 [L].

Moreover, with regard to an internal-combustion-engine control apparatus according to Embodiment 1 of the present invention, it has been described that the supercharging pressure ratio is 2.0; however, there can be utilized an internal-combustion-engine control apparatus in which a supercharging pressure ratio of the same as or larger than 2.0 is obtained by providing an electrically assisted turbocharger with a larger capacity. In that case, the cylinder capacity of an internal combustion engine can further be reduced; therefore, further downsizing can be performed, and the gasoline mileage performance is raised. According to the present invention, in the case where the supercharging pressure ratio of an electrically assisted turbocharger is the same as or larger than 2.0, the same effect can be demonstrated.

Still moreover, an internal-combustion-engine control apparatus according to the present invention can also obtain the same effect, for example, in the case where it is configured in such a way that a mechanical turbocharger is provided after an electrically assisted turbocharger, i.e., in the case where it is a twin-turbo control apparatus.

Heretofore, internal-combustion-engine control apparatuses according to the present invention have been explained; however, it should be understood that the present invention is not limited to the illustrative embodiments set forth herein, and various modifications and alterations of this invention will be apparent to those skilled in the art without departing from the scope and spirit of this invention.

What is claimed is:

1. An internal-combustion-engine control apparatus comprising:
an electrically assisted turbocharger including:
a turbine wheel that is provided in an exhaust path of an internal combustion engine mounted in a vehicle and is driven with exhaust gas energy of the internal combustion engine;
a compressor impeller that is provided in an air-intake path of the internal combustion engine and is driven by the turbine wheel so as to compress the air in the air-intake path; and
a motor that exerts assisting torque on the compressor impeller, as may be necessary, and
a control means that controls the electrically assisted turbocharger, based at least on an acceleration intention of a driver who drives the vehicle,
wherein output torque of the internal combustion engine is increased by supercharging the internal combustion engine with air compressed by the compressor impeller; and when the acceleration intention is to require acceleration that is more rapid than a predetermined value, the control means controls the motor in such a way that the motor generates assisting torque for compensating inertia moments of at least the turbine wheel, the compressor impeller, and the motor.

2. The internal-combustion-engine control apparatus according to claim 1, wherein the acceleration intention of the driver is obtained based on the displacement speed of a throttle position of the internal combustion engine; and in the case where the displacement speed of the throttle position is the same as or higher than a predetermined value, it is determined that the acceleration intention of the driver is to require acceleration that is more rapid than the predetermined value, and in the case where the displacement speed of the throttle position is lower than the predetermined value, it is determined that the acceleration intention of the driver is not to require acceleration that is more rapid than the predetermined value.

3. The internal-combustion-engine control apparatus according to claim 1, further including:
a recirculation path for returning air at the downstream side of the compressor impeller in the air-intake path to the upstream side of the compressor impeller; and
an air flow rate adjusting means that controls the ratio of an air pressure at the downstream side of the compressor impeller to an air pressure at the upstream side of the compressor impeller by adjusting an air flow rate in the recirculation path,
wherein the air flow rate adjusting means adjusts an air flow rate in the recirculation path, based at least on an air pressure at the downstream side of the compressor impeller and the assisting torque of the motor.

4. The internal-combustion-engine control apparatus according to claim 1, wherein the rotation speed of the electrically assisted turbocharger is lower than 200,000 [rpm], and the electrically assisted turbocharger has a capacity where the ratio of an air pressure at the downstream side of the compressor impeller to an air pressure at the upstream side of the compressor impeller is the same as or larger than 2.0.

5. An internal-combustion-engine control apparatus comprising:
an electrically assisted turbocharger including:
a turbine wheel that is provided in an exhaust path of an internal combustion engine mounted in a vehicle and is driven with exhaust gas energy of the internal combustion engine;
a compressor impeller that is provided in an air-intake path of the internal combustion engine and is driven by the turbine wheel so as to compress the air in the air-intake path; and
a motor that exerts assisting torque on the compressor impeller, as may be necessary, and
a control means that controls the electrically assisted turbocharger, based at least on an acceleration intention of a driver who drives the vehicle and a rotation speed of the internal combustion engine,
wherein output torque of the internal combustion engine is increased by supercharging the internal combustion engine with air compressed by the compressor impeller; and in the case where the acceleration intention is not to require acceleration that is more rapid than a predetermined value and the rotation speed is the same as or lower than a predetermined rotation speed, the control means controls the motor in such a way that the motor drives the compressor impeller with assisting torque thereof, and in the case where the acceleration intention is not to require acceleration that is more rapid than the predetermined value and the rotation speed is higher than the predetermined rotation speed, the control means de-energizes the motor so that the compressor impeller is driven only with torque of the turbine wheel.

6. The internal-combustion-engine control apparatus according to claim 5, wherein the acceleration intention of the driver is obtained based on the displacement speed of a throttle position of the internal combustion engine; and in the case where the displacement speed of the throttle position is the same as or higher than a predetermined value, it is determined that the acceleration intention of the driver is to require acceleration that is more rapid than the predetermined value, and in the case where the displacement speed of the throttle position is lower than the predetermined value, it is determined that the acceleration intention of the driver is not to require acceleration that is more rapid than the predetermined value.

7. The internal-combustion-engine control apparatus according to claim 5, further including:
a recirculation path for returning air at the downstream side of the compressor impeller in the air-intake path to the upstream side of the compressor impeller; and
an air flow rate adjusting means that controls the ratio of an air pressure at the downstream side of the compressor impeller to an air pressure at the upstream side of the compressor impeller by adjusting an air flow rate in the recirculation path,
wherein the air flow rate adjusting means adjusts an air flow rate in the recirculation path, based at least on an air pressure at the downstream side of the compressor impeller and the assisting torque of the motor.

8. The internal-combustion-engine control apparatus according to claim 5, wherein the rotation speed of the electrically assisted turbocharger is lower than 200,000 [rpm], and the electrically assisted turbocharger has a capacity where the ratio of an air pressure at the downstream side of the compressor impeller to an air pressure at the upstream side of the compressor impeller is the same as or larger than 2.0.

9. An internal-combustion-engine control apparatus comprising:
an electrically assisted turbocharger including:
a turbine wheel that is provided in an exhaust path of an internal combustion engine mounted in a vehicle and is driven with exhaust gas energy of the internal combustion engine;
a compressor impeller that is provided in an air-intake path of the internal combustion engine and is driven by the turbine wheel so as to compress the air in the air-intake path; and
a motor that exerts assisting torque on the compressor impeller, as may be necessary, and
a control means that controls the electrically assisted turbocharger, based at least on a rotation speed of the internal combustion engine,
wherein output torque of the internal combustion engine is increased by supercharging the internal combustion engine with air compressed by the compressor impeller; and when the output torque of the internal combustion engine is increased at a more higher rotation speed than a predetermined rotation speed of the internal combustion engine, the control means controls the motor in such a way that the motor generates assisting torque for compensating inertia moments of at least the turbine wheel, the compressor impeller, and the motor.

10. The internal-combustion-engine control apparatus according to claim 9, wherein the rotation speed of the electrically assisted turbocharger is lower than 200,000 [rpm], and the electrically assisted turbocharger has a capacity where the ratio of an air pressure at the downstream side of the compressor impeller to an air pressure at the upstream side of the compressor impeller is the same as or larger than 2.0.

11. The internal-combustion-engine control apparatus according to claim 10, wherein the internal combustion engine is provided with a cylinder whose volume is smaller than 1.4 [L].
